(19) United States
(12) Patent Application Publication
(10) Pub. No.: US 2015/0341705 A1
(43) Pub. Date: Nov. 26, 2015

(54) Network content delivery method using a delivery helper node

(71) Applicant: Akamai Technologies, Inc., Cambridge, MA (US)

(72) Inventors: Theis Rauhe, Olstykke (DK); Christian Mortensen, Kobenhavn (DK); Scott Brown, Marietta, GA (US)

(21) Appl. No.: 14/814,610

(22) Filed: Jul. 31, 2015

Related U.S. Application Data
(63) Continuation of application No. PCT/DK2013/050029, filed on Jan. 31, 2013.

(51) Int. Cl. H04N 21/6373; H04L 12/24; H04N 21/6405

(52) U.S. Cl. CPC H04N 21/6373; H04N 21/6405; H04L 41/083

(57) ABSTRACT

The disclosure relates to a content delivery method for delivering content to a content receiver in a network where a transmission control node and delivery helper nodes have access to the content, the method comprising negotiating a network connection in accordance with a reliable transport protocol between the transmission control node and the content receiver; controlling the delivery helper nodes to establish content packets with headers in accordance with the negotiated network connection and transmitting them to the content receiver; which again transmits acknowledgement packets to the transmission control node. The disclosure further relates to corresponding delivery helper nodes, transmission control nodes, and a content delivery network comprising such.

### FIELD OF THE INVENTION

The present disclosure relates to content delivery in data networks such as the Internet.

### BACKGROUND OF THE INVENTION

It may sometimes be necessary or beneficial to use a standardized and widely supported transport protocol of the reliable type such as the Transmission Control Protocol TCP when delivering content to a content receiver in a data network such as the Internet. Using a protocol like TCP can for example be necessary or the most usable of a few alternatives on hardware platforms where strict firewalls, software limitations, etc. apply, e.g. in many of the huge amount of Internet-connectable devices that are acquired in both business and private markets, including e.g. smartphones, TVs, etc. On the other hand, the delivery of data-heavy content such as audio/video, software packages or databases is often delivered from a cloud or other online servers by a transport protocol of the unreliable type such as the User Datagram Protocol UDP, a multicast protocol or a proprietary or otherwise less supported protocol in order to require much less of the connection from the server to the content receiver.

### SUMMARY OF THE INVENTION

The inventor has identified a problem related to the delivering of data-heavy content to a content receiver expecting the use of a reliable transport protocol, but where the overall connection from a content server to the content receiver would become ineffective or otherwise problematic if restricted to only using the reliable transport protocol.

An object of the disclosure is to provide a content delivery method that works like a reliable transport protocol as seen from the content receiver, but which is less restricted with respect to the connection when it comes to the transport of data from the content server to the content receiver.

An object of the disclosure is to provide a multi-route content delivery method which as seen from the content receiver's end is compatible with conventional, widely supported reliable transport protocols such as TCP.

An object of the disclosure is to provide a method for reducing the bandwidth necessary for serving heavy content such as live streaming or video-on-demand to Internet-connected devices that require a TCP connection.

The disclosure relates to a content delivery method for delivering content to a content receiver R in a network comprising a transmission control node S and one or more delivery helper nodes DHN, both the transmission control node S and the delivery helper node DHN having access to said content, the content delivery method comprising
negotiating a network connection in accordance with a reliable transport protocol between said transmission control node S and said content receiver R, the negotiated network connection at least comprising the content receiver R receiving content packets CP and sending acknowledgment packets ACK;
controlling said one or more delivery helper nodes DHN to establish content packets CP with headers in accordance with said negotiated network connection;
transmitting the established content packets CP from said delivery helper nodes DHN to said content receiver R; and
transmitting said acknowledgement packets ACK from said content receiver R to said transmission control node S.

According to the present disclosure, a new and advantageous method is provided of enabling distribution of resources in a content delivery situation, and yet both support and conform to a transport protocol of the reliable type as seen from the content recipient's point of view. In certain embodiments the present invention improves the reliable transport protocols like TCP with properties such as scalability, flexibility in routing and bitrate, and resiliency.

The present disclosure is particularly advantageous when the one-to-one connection conventionally needed for a reliable transport protocol is problematic, impossible or just not cost-effective, but the use of a reliable transport protocol is nevertheless required or desirable for other reasons. This is for example the case for many of the light and/or specialized Internet-connected devices such as smartphones, smart TV's, gaming consoles, etc., which often have very limited options for installing special software or using network protocols not compatible with e.g. the HTTP, or devices that are simply only allowing one specific protocol for e.g. video streaming, such as e.g. the HLS or MPEG-DASH standards. It could also be the case in some environment that the properties of a reliable transport protocol was just desirable, e.g. congestion control, flow control, etc., and therefore justifies the added complexity of the present disclosure's extended use of reliable transport protocols.

By the present disclosure it is made possible for the content sender to establish a many-to-one connection with the look and feel of a one-to-one connection, and this feature is a key to suddenly being able to for example distribute heavy content transmission to a sender closer to the receiver or to several senders, or perhaps find a sender on the other side of a network bottleneck, or with more available resources, or that already has cached the content to be sent, etc.

The present invention further enables extending an existing non-reliable distribution network, e.g. a multicast, grid or peer-to-peer distribution network, to also be able to serve the above-mentioned limited devices that are restricted to e.g. the TCP, by allowing distribution of content through the non-reliable distribution network even though the receiver has requested a reliable, e.g. TCP, connection from a backend TCP entry point.

Also for cloud-based content delivery is the present disclosure very advantageous if a significant part of the content receivers are TCP-only devices. Conventionally such content receivers would not be able to benefit from multicast, Automatic Multicast Tunnelling or other ways to increase the scalability and reduce the load imposed by each receiver on the cloud resources, which also has an economical aspect. Instead each receiver would need their own heavy TCP connection to inside the cloud, or TCP entry points would have to be established locally anywhere TCP-only devices were used. However, by means of the present invention, only light TCP connections have to be maintained from each receiver to the backend, whereas the heavy content delivery can be performed by existing scalable infrastructure, and still with the look and feel of a single TCP connection as seen from the receiver.

The above advantages are according to the present disclosure achieved by having the backend TCP entry point, the transmission control node, establish the requested TCP connection, but making one or more special network nodes, the delivery helper nodes, of the, e.g. multicast or grid, network that is nearer by some dimension, e.g. distance, hops, resources, bandwidth, etc., able to actually send TCP content packets on behalf of the transmission control node and from the receiver's point of view fully conformant to the TCP.

According to the present disclosure, the content can be any kind of data, but the present invention is particularly advantageous for delivery of heavy content such as e.g. live video streaming, video-on-demand files, progressive download, big databases, software packages, etc.

The content receiver may be any network-connection device that is able to request data in accordance with a reliable transport protocol.

A network is according to the present disclosure preferably the Internet or a local network, preferably a TCP/IP network, but any data or communication network that supports connecting several nodes and routing mechanisms featuring a reliable transport protocol is within the scope of the disclosure.

The transmission control node is according to the present disclosure typically a server or other backend device set up to enable connections according to a reliable transport protocol e.g. TCP, but can also be implemented in a router-like network node or in a peer of a grid or peer-to-peer network.

The delivery helper node is according to the present disclosure typically implemented in a router-like network node, but may also be a server or a peer of a grid or peer-to-peer network. The delivery helper node is preferably a normally functioning router, preferably a multicast or AMT enabled router, which is enhanced with the delivery helper node functionality according to the present invention. The delivery helper node may also within the invention be a very specialized node primarily focused on serving TCP content packets on behalf of transmission control nodes.

According to the disclosure, the transmission control node and the delivery helper node having access to the content may be achieved by storing the content at the nodes, or by having the nodes receiving the content from a content storage or generator, possibly via any content delivery method and intermediate infrastructure. The transmission control node and the delivery helper node do not necessarily have the same type of access to the content. In an embodiment the delivery helper node accesses the content via the transmission control node or vice versa.

By negotiating a network connection according to the present disclosure is referred to the handshaking or other connection establishing mechanisms used in reliable transport protocols and related protocols to initialize a connection between two parties. The negotiation may e.g. comprise requesting a connection, agreeing on packet size, window size, sequence numbering, etc.

According to the present disclosure a reliable transport protocol is a protocol that includes rules or mechanisms for dealing with packet loss, ordering etc. The term reliable is a commonly used term for protocols that include such properties, contrary to unreliable protocols where packet loss are not necessarily dealt with. The Transmission Control Protocol is preferred and by far the most widely used reliable transport protocol.

According to the present disclosure the delivery helper node establishes content packets with headers in accordance with the negotiated network connection. In a preferred embodiment the delivery helper node is itself receiving content packets and simply translate and manipulate the headers of the received content packets to conform to the negotiated network connection, i.e. being headers of a reliable transport protocol. In another embodiment the delivery helper node divides the content into content packets and wraps them in headers accordingly. The transmission control node and the delivery helper node should preferably be in synchrony with regard to the division of the content into packets, which packet has which sequence number, etc., as in a preferred embodiment it is a task for the transmission control node to retransmit any lost content packets. A preferred way to be in synchrony is to have both the transmission control node and the delivery helper node receiving the same content packets.

According to the present disclosure the transmitting the content packets from the delivery helper node to the content receiver and transmitting the acknowledgement packets from the content receiver to the transmission control node is preferably performed via a network such as the Internet or a local area network, and the transmission may be a single hop or through a network infrastructure of any kind.

An advantageous embodiment of the present disclosure is obtained when said reliable transport protocol is a Transmission Control Protocol TCP.

An advantageous embodiment of the present disclosure is obtained when the content delivery method comprises the delivery helper nodes having access to said content by receiving content packets representing said content in accordance with an unreliable transport protocol.

An advantageous embodiment of the present disclosure is obtained when said unreliable transport protocol is a User Datagram Protocol UDP.

An advantageous embodiment of the present disclosure is obtained when said unreliable transport protocol is a multicast protocol.

An advantageous embodiment of the present disclosure is obtained when said established content packets transmitted from said delivery helper node identify said transmission control node as source.

According to the disclosure the delivery helper node preferably inserts the transmission control node as the source address. In a preferred embodiment where the reliable transport protocol is the TCP, the source address is identified in the IP-header of the packets. By using the transmission control node's address instead of its own address, the delivery helper node ensures that the content receiver will recognize the content packets as part of the established TCP connection, and that it will send acknowledgement packets to the transmission control node instead of the delivery helper node.

An advantageous embodiment of the present disclosure is obtained when said content comprises live video streaming.

The present disclosure is particularly advantageous when the content represents a live stream, e.g. a video stream. In this context live video streaming refers to a video stream corresponding to a broadcast, i.e. a common video stream that may be received by several recipients more or less simultaneously, representing a live event or a broadcast of a pre-recorded video production. Streaming should be understood broadly as comprising any way of delivering a content that has duration in time, possibly an unknown duration, e.g. a live sports event, broadcast of a TV channel, a movie, frequent database updates, etc., and where the content receiver may begin using the content, in the case of video streaming: begin watching the broadcast, before the entire streaming has ended. Typically the receiver can begin using the content after one or a few frames have been received, or after a buffer has been filled. As the present disclosure allows a content delivery network to be scalable also with regard to TCP-only recipients, the present disclosure is also for this reason particularly advantageous when several recipients request the same content, which is typically the case with live video streaming.

An advantageous embodiment of the present disclosure is obtained when said content comprises video-on-demand streaming.

According to the present disclosure, also progressive downloads, video-on-demand streaming or download, distribution of software packages, etc. may be more efficiently deployed by means of the delivery helper nodes than if the content receiver should obtain the entire content from the transmission control node or the backend content server. In a preferred embodiment, the delivery helper node has a better, e.g. lighter, easier or faster, and/or cheaper access to the content, and is preferably also closer to the content receiver.

An advantageous embodiment of the present disclosure is obtained when said negotiated network connection is compatible with a HyperText Transfer Protocol HTTP.

According to a preferred embodiment of the disclosure the method can be used from any web browser, network client, smartphone app, etc., that supports HTTP, which is an extremely widely supported application layer protocol, which is often supported on even very limited devices, and on which several streaming or content delivery standards build. A great advantage of an embodiment of the present disclosure is, that the content receiver doesn't need to know or relate to the fact that the HTTP-stream may actually be sent from two or more sources, i.e. the transmission control node and one or more delivery helper nodes, which means, that the present disclosure can be used as a substitute for any HTTP-connection if just the sources or routers somewhere on the trace are configured to it.

An advantageous embodiment of the present disclosure is obtained when said negotiated network connection conforms to a HTTP Live Streaming, HLS, standard or a Dynamic Adaptive Streaming over HTTP, MPEG-DASH, standard.

Following from the above, all the advantages of the present disclosure can in an embodiment be utilised for streaming content according to the widely used HLS or MPEG-DASH standards which build on the HTTP, thus making it possible to reduce the load significantly on networks with many, e.g. HLS, requests. While these standards may benefit particularly from the present disclosure, several other formats are also within the scope of the disclosure and may benefit from it, for example MPEG Transport Stream, MPEG-TS, specified in MPEG-2.

An advantageous embodiment of the present disclosure is obtained when said content receiver is a smartphone, a network enabled TV, a gaming console, a tablet, etc., as such devices are often very limited in their support for networking protocols and/or their possibilities for installing software to download content in other ways.

An advantageous embodiment of the present disclosure is obtained when said delivery helper node is implemented in a network router, a multicast enabled network router, or an Automatic Multicast Tunnelling, AMT, enabled router.

According to the present disclosure, the delivery helper node should have access to the content and should be able to send packages to the content receiver. Hence it is preferably a component in a network comprising both a source for the content and the content receiver. Implementing the delivery helper node in a router-type network component is very beneficial as such components are scattered all over a network anyway and are necessary for establishing the routes, and could advantageously just also feature the delivery helper node functionality according to the present disclosure

Implementing the delivery helper node in a multicast- or AMT router makes it even more advantageous, as this gives the delivery helper node a very easy and light access to the content, provided it is made accessible by multicast.

An advantageous embodiment of the present disclosure is obtained when said delivery helper node is implemented in a local gateway or in a home router.

A particularly beneficial use of the present disclosure is to enable a local gateway or home router to act as delivery helper node, as there may often be several devices in a LAN or home network that request the same content stream, e.g. two TV's, a TV and a tablet, etc., and by having a local delivery helper node, the transmission control node will be able to serve the local, limited devices directly from their own local gateway, only needing to download the content once to the gateway for local distribution in the LAN. Even in case only one device requests the content stream, the distribution system may benefit from the locally deployed delivery helper node as it is will probably be on the content receiver's side of any bottleneck between the transmission control node and the content receiver.

An advantageous embodiment of the present disclosure is obtained when said content delivery method comprises the transmission control node estimating a network connection capacity, determining an estimate for a bandwidth of the negotiated network connection and/or determining a measure for a packet loss ratio of the negotiated network connection.

According to preferred embodiments of the disclosure, the transmission control node makes estimates about network parameters, preferably based on the feedback, e.g. acknowledgement packets, it receives from the receiver and possibly also feedback received from the delivery helper node(s). The capacity, bandwidth and packet loss estimates may also be based on results from a different network connection that is thought to be representative, or analysis of several kinds of measurements, e.g. missing acknowledgement packets, duplicated packets, time for receipt, etc.

With normal TCP connections both packet loss ratio and round trip time RTT may be calculated based on the acknowledgement packets and information about when content packets were sent. In the scope of the present disclosure, where lots of content packets are preferably sent from the delivery helper node(s), the transmission control node does not have the same basis for determining the RTT. In a preferred embodiment the transmission control node estimates an RTT by estimating the sending time of content packets, and comparing with the time of receipt of corresponding acknowledgment packets.

In a preferred embodiment the estimated RTT and packet loss ratio, or other capacity-related estimates, may be used for the transmission control node to estimate e.g. the bandwidth, find bottlenecks, or adjust or suggest adjusting the sending data rate to best fit the estimated circumstances or compete fair with other, e.g. TCP, connections on the same routes.

An advantageous embodiment of the present disclosure is obtained when said content delivery method comprises controlling the one or more delivery helper nodes at least partly on the basis of an estimated measure for a network capacity, bandwidth or a packet loss ratio, of the negotiated network connection.

An advantageous embodiment of the present disclosure is obtained when said content delivery method comprises deciding a content bitrate at least partly on the basis of quality properties of the negotiated network connection.

In a preferred, very advantageous embodiment of the present disclosure, two or more different bitrates, i.e. qualities, of the same content can be served to the receiver, e.g. by providing different delivery data helpers each serving different bitrate versions of the content, or making one delivery data helper serve different streams with different bitrates. In an embodiment the receiver selects a bitrate among the available bitrates, but in preferred embodiments the transmission control node determines or at least suggests an appropriate bitrate based on e.g. some of the above-mentioned network parameters. In a preferred embodiment the transmission control node further adjusts the bitrate served to the receiver when needed or beneficial in accordance with changes in the connection parameters or circumstances.

An advantageous embodiment of the present disclosure is obtained when the network comprises at least two delivery helper nodes serving the content at different bitrates; the content delivery method comprising deciding a content bitrate from said different bitrates.

An advantageous embodiment of the present disclosure is obtained when the network comprises a delivery helper node serving the content at two or more different bitrates; the content delivery method comprising deciding a content bitrate from said two or more different bitrates.

An advantageous embodiment of the present disclosure is obtained when said content delivery method comprises regularly transmitting a number of content packets from said transmission control node or said one or more delivery helper nodes to said content receiver in order to determine network or receiver capacity.

An advantageous embodiment of the present disclosure is obtained when said number of content packets transmitted to said content receiver in order to determine network or receiver capacity is transmitted at a higher data rate or more frequently than previous content packets in order to determine if a faster connection is possible.

According to a preferred embodiment of the disclosure the transmission control node and/or the delivery helper node(s) occasionally sends a number of content packets in bursts, i.e. at a higher frequency and/or at a higher data rate, than normally used for the transmission. The acknowledgment packets received after a burst may tell the transmission control node to what degree the network route between the transmission control node and/or the delivery helper node(s), respectively, has capacity to handle faster transmission of regular content packets. If the burst packets do not build up at a bottleneck buffer but are received at an acceptable rate, i.e. corresponding to the transmission rate, and without packet loss, then the transmission control node may decide to adjust the bitrate. Such adjustments have to be synchronised with the delivery helper node(s) before taking place.

In other words, a short burst requires more from the connection, and if successful, it can be determined that the connection has available capacity, and the regular transmission level can be increased.

In a preferred embodiment of the present disclosure, the transmission control node may also decide to decrease the data rate based on the received acknowledgment packets and network parameters determined from them. For example, if acknowledgment packets indicate that the receipt of content packets is delayed, and that the delay increases over time, it may imply that congestion problems exists, and the transmission control node may decrease the data rate by synchronising this with the delivery helper node(s).

An advantageous embodiment of the present disclosure is obtained when a further network connection is established between the content receiver and the one or more delivery helper nodes.

In an embodiment of the present disclosure, a separate connection may be established between the content receiver and one or more of the delivery helper node(s). The separate connection may be of any type, but a TCP connection is preferred. This embodiment may e.g. comprise the content receiver R frequently contacting the delivery helper node DHN with keep alive packets, e.g. so that the delivery helper node may discover a possible disappearance of the content receiver R before or instead of receiving that information from the transmission control node S. When receiving some amount of traffic directly from the content receiver, for example regular keep-alive messages, the delivery helper node DHN may be arranged to determine some connection parameters by itself by measuring the local round trip time RTT. The delivery helper node may e.g. use this for performing rate-based congestion control, or for determining considerable differences between the connection from the delivery helper node to the receiver compared with the connection from the transmission control node to the receiver. In several scenarios where the present disclosure is advantageous is may very well be that the TCP throughput from the helper node to the receiver is better than the throughput from the transmission control node to the receiver, because the helper node is preferably closer to the receiver, in terms of network hops and/or geographically, and is preferably located on the receiver side of any bottleneck between the transmission control node and the content receiver. In an embodiment of the disclosure, the information from the content receiver R to the delivery helper node DHN may include all or part of the information necessary for the delivery helper node to establish the TCP content packets, and further information from the transmission control node S may thereby be fully or partly dispensed with.

An advantageous embodiment of the present disclosure is obtained when said content delivery method comprises controlling the one or more delivery helper nodes at least partly on the basis of properties of further network connections established between the content receiver and the one or more delivery helper nodes.

An advantageous embodiment of the present disclosure is obtained when the content delivery method comprises the transmission control node monitoring the acknowledgement packets and instructing the one or more delivery helper nodes to temporarily stop transmission of said content packets when the received acknowledgement packets indicate a connection irregularity.

A connection irregularity may e.g. comprise congestion situations, bottleneck packet build up, temporary loss of the connection to the content receiver, exceed TCP window size, etc.

An advantageous embodiment of the present disclosure is obtained when the content delivery method comprises the transmission control node occasionally instructing the delivery helper node to temporarily stop the transmission of content packets and the transmission control node transmitting packets to the content receiver while the delivery helper node transmission is temporarily stopped.

In preferred embodiments the transmission control node may take over the transmission of packets to the content receiver temporarily e.g. for resending lost packets, or in order to test the connection parameters or network capacity. Further embodiments of the disclosure where the transmission control node temporarily pauses the delivery helper node transmission and sends packets to the content receiver may e.g. comprise blocks of commercials received from a separate stream or controlled by the transmission control node.

An advantageous embodiment of the present disclosure is obtained when the transmission control node informs the one or more delivery helper nodes about the negotiated network connection, at least regarding packet sequence numbering.

The present disclosure further relates to a delivery helper node DHN arranged in a network, the delivery helper node DHN having access to a content, wherein the delivery helper node DHN is further arranged to
receive control information from a transmission control node S about a negotiated network connection between the transmission control node S and a content receiver R, the negotiated network connection being in accordance with a reliable transport protocol;
establish content packets CP which have headers according to said reliable transport protocol;
transmit the established content packets CP to a content receiver R;
   wherein said content packets CP are established on the basis of said content and said control information, and wherein a source address in said headers represents an address associated with said negotiated network connection, the source address being different from an address of said delivery helper node DHN.

According to the present disclosure, a delivery helper node is provided, which may be controlled by a transmission control node to establish and transmit content packets to a content receiver according to a reliable transport protocol, e.g. the TCP protocol, but where the delivery helper node is instructed to identify the source by a different address, e.g. IP-address in the case of the TCP protocol, than its own address. This is very advantageous, as it allows for the transmission control node to actually tweak the inherently one-to-one type of connection that reliable transport protocols offer, and make it practically into a many-to-one connection, and this without the content receiver having to know about it or make any adjustments for that reason. The delivery helper node according to the present disclosure establishes a network unit that the transmission control node can delegate a part of the sending obligations in a TCP connection to. This is particularly advantageous for large data content, especially when also stretching over time, like e.g. live video streaming, as the heavy and enduring transmissions can be delegated to delivery data helpers even though the reliable connections have been set up by other network components, in this case referred to as transmission control nodes.

An advantageous embodiment of the present disclosure is obtained when said reliable transport protocol is a Transmission Control Protocol TCP.

An advantageous embodiment of the present disclosure is obtained when the control information at least comprising a source address, a destination address and a packet sequence number.

In a preferred embodiment the control information enables the delivery helper node to adjust content packet headers to make them conform to a connection established by another party, here referred to as the transmission control node. In a preferred embodiment, the negotiated network connection is a TCP connection, and the delivery helper node adjusts IP- and TCP-headers to e.g. reflect the transmission control node as the source instead of the delivery helper node, and by inserting the packet sequence number that is in accordance with packets already sent to the content receiver by that connections, regardless of who the physical sender of previous packets has been.

An advantageous embodiment of the present disclosure is obtained when said access to said content is arranged by the delivery helper node being arranged to receive content packets in accordance with an unreliable transport protocol.

An advantageous embodiment of the present disclosure is obtained when said unreliable transport protocol is a User Datagram Protocol UDP.

An advantageous embodiment of the present disclosure is obtained when said unreliable transport protocol is a multicast protocol.

An advantageous embodiment of the present disclosure is obtained when said source address is the address of said transmission control node S.

An advantageous embodiment of the present disclosure is obtained when said destination address is the address of said content receiver R.

An advantageous embodiment of the present disclosure is obtained when said delivery helper node is implemented in a network router, a multicast enabled network router, or an Automatic Multicast Tunnelling, AMT, enabled router.

According to the present disclosure, the delivery helper node should have access to the content and should be able to send packages to the content receiver. Hence it is preferably a component in a network comprising both a source for the content and the content receiver. Implementing the delivery helper node in a router-type network component is very beneficial as such components are scattered all over a network anyway and are necessary for establishing the routes, and could advantageously just also feature the delivery helper node functionality according to the present disclosure.

Implementing the delivery helper node in a multicast- or AMT router makes it even more advantageous, as this gives the delivery helper node a very easy and light access to the content, provided it is made accessible by multicast.

An advantageous embodiment of the present disclosure is obtained when said delivery helper node is implemented in a local gateway or in a home router.

A particularly beneficial use of the present disclosure is to enable a local gateway or home router to act as delivery helper node, as there may often be several devices in a LAN or home network that request the same content stream, e.g. two TV's, a TV and a tablet, etc., and by having a local delivery helper node, the transmission control node will be able to serve the local, limited devices directly from their own local gateway, only needing to download the content once to the gateway for local distribution in the LAN. Even in case only one device requests the content stream, the distribution system may benefit from the locally deployed delivery helper node as it is will probably be on the content receiver's side of any bottleneck between the transmission control node and the content receiver.

The present disclosure further relates to a transmission control node S arranged in a network, the transmission control node S having access to a content, wherein the transmission control node S is further arranged to
negotiate a network connection between the transmission control node S and a content receiver R, the negotiated network connection being in accordance with a reliable transport protocol;
transmit control information about the negotiated network connection to a delivery helper node DHN;
allocate to said delivery helper node DHN the transmission to said content receiver R of at least some content packets CP established on the basis of said content and said control information;
receive acknowledgement packets ACK associated with at least some of said content packets CP from said content receiver R;
   wherein said content packets CP are established with headers in accordance with a reliable transport protocol, and wherein a source address associated with said negotiated network connection is different from an address of said delivery helper node DHN.

According to the present disclosure, a transmission control node is provided, which may set up a connection to a content receiver according to a reliable transport protocol, e.g. the TCP protocol, but nevertheless delegate some of the content transmission work to other network nodes, referred to as delivery helper nodes. This is very advantageous, as it allows for the transmission control node to actually tweak the inherently one-to-one type of connection that reliable transport protocols offer, and make it practically into a many-to-one connection, and this without the content receiver having to know about it or make any adjustments for that reason. This is particularly advantageous for large data content, especially when also stretching over time, like e.g. live video streaming, as the heavy and enduring transmissions can be delegated to delivery data helpers even though the reliable connections have been set up by the transmission control node.

An advantageous embodiment of the present disclosure is obtained when said reliable transport protocol is a Transmission Control Protocol TCP.

An advantageous embodiment of the present disclosure is obtained when the control information at least comprising a source address, a destination address and a packet sequence number.

In a preferred embodiment the control information enables the delivery helper node to adjust content packet headers to make them conform to a connection established by the transmission control node. In a preferred embodiment, the negotiated network connection is a TCP connection, and the delivery helper node adjusts IP- and TCP-headers to e.g. reflect the transmission control node as the source instead of the delivery helper node, and by inserting the packet sequence number that is in accordance with packets already sent to the content receiver by that connections, regardless of who the physical sender of previous packets has been.

An advantageous embodiment of the present disclosure is obtained when said source address is the address of said transmission control node S.

An advantageous embodiment of the present disclosure is obtained when said destination address is the address of said content receiver R.

An advantageous embodiment of the present disclosure is obtained when said negotiated network connection is compatible with a HyperText Transfer Protocol HTTP.

According to a preferred embodiment of the disclosure the method can be used from any web browser, network client, smartphone app, etc., that supports HTTP, which is an extremely widely supported application layer protocol, which is often supported on even very limited devices, and on which several streaming or content delivery standards build. A great advantage of an embodiment of the present disclosure is, that the content receiver doesn't need to know or relate to the fact that the HTTP-stream may actually be sent from two or more sources, i.e. the transmission control node and one or more delivery helper nodes, which means, that the present disclosure can be used as a substitute for any HTTP-connection if just the sources or routers somewhere on the trace are configured to it.

An advantageous embodiment of the present disclosure is obtained when said negotiated network connection conforms to a HTTP Live Streaming, HLS, standard or a Dynamic Adaptive Streaming over HTTP, MPEG-DASH, standard.

Following from the above, all the advantages of the present disclosure can in an embodiment be utilised for streaming content according to the widely used HLS or MPEG-DASH standards which build on the HTTP, thus making it possible to reduce the load significantly on networks with many, e.g. HLS, requests. While these standards may benefit particularly from the present disclosure, several other formats are also within the scope of the disclosure and may benefit from it, for example MPEG Transport Stream, MPEG-TS, specified in MPEG-2.

An advantageous embodiment of the present disclosure is obtained when the transmission control node is arranged to estimate a network connection capacity, determine an estimate for a bandwidth of the negotiated network connection and/or determine a measure for a packet loss ratio of the negotiated network connection.

According to preferred embodiments of the disclosure, the transmission control node makes estimates about network parameters, preferably based on the feedback, e.g. acknowledgement packets, it receives from the receiver and possibly also feedback received from the delivery helper node(s). The capacity, bandwidth and packet loss estimates may also be based on results from a different network connection that is thought to be representative, or analysis of several kinds of measurements, e.g. missing acknowledgement packets, duplicated packets, time for receipt, etc.

With normal TCP connections both packet loss ratio and round trip time RTT may be calculated based on the acknowledgement packets and information about when content packets were sent. In the scope of the present disclosure, where lots of content packets are preferably sent from the delivery helper node(s), the transmission control node does not have the same basis for determining the RTT. In a preferred embodiment the transmission control node estimates an RTT by estimating the sending time of content packets, and comparing with the time of receipt of corresponding acknowledgment packets.

In a preferred embodiment the estimated RTT and packet loss ratio, or other capacity-related estimates, may be used for the transmission control node to estimate e.g. the bandwidth, find bottlenecks, or adjust or suggest adjusting the sending data rate to best fit the estimated circumstances or compete fair with other, e.g. TCP, connections on the same routes.

An advantageous embodiment of the present disclosure is obtained when said control information is at least partly based on an estimated measure for a network capacity, bandwidth or a packet loss ratio, of the negotiated network connection.

An advantageous embodiment of the present disclosure is obtained when the transmission control node is arranged to determine a content bitrate at least partly on the basis of quality properties of the negotiated network connection.

In a preferred, very advantageous embodiment of the present disclosure, two or more different bitrates, i.e. qualities, of the same content can be served to the receiver, e.g. by providing different delivery data helpers each serving different bitrate versions of the content, or making one delivery data helper serve different streams with different bitrates. In an embodiment the receiver selects a bitrate among the available bitrates, but in preferred embodiments the transmission control node determines or at least suggests an appropriate bitrate based on e.g. some of the above-mentioned network parameters. In a preferred embodiment the transmission control node further adjusts the bitrate served to the receiver when needed or beneficial in accordance with changes in the connection parameters or circumstances.

An advantageous embodiment of the present disclosure is obtained when the transmission control node determines a content bitrate and selects the delivery helper node from a set of delivery helper nodes with associated bitrates of said content, at least partly on the basis of said determined content bitrate.

An advantageous embodiment of the present disclosure is obtained the control information comprises information about a content bitrate.

An advantageous embodiment of the present disclosure is obtained when the transmission control node is arranged to determine network or receiver capacity by controlling that a number of content packets are regularly transmitted from the transmission control node or the delivery helper node to said content receiver.

An advantageous embodiment of the present disclosure is obtained when said number of content packets transmitted to said content receiver in order to determine network or receiver capacity is transmitted at a higher data rate or more frequently than previous content packets in order to determine if a faster connection is possible.

According to a preferred embodiment of the disclosure the transmission control node and/or the delivery helper node(s) occasionally sends a number of content packets in bursts, i.e. at a higher frequency and/or at a higher data rate, than normally used for the transmission. The acknowledgment packets received after a burst may tell the transmission control node to what degree the network route between the transmission control node and/or the delivery helper node(s), respectively, has capacity to handle faster transmission of regular content packets. If the burst packets do not build up at a bottleneck buffer but are received at an acceptable rate, i.e. corresponding to the transmission rate, and without packet loss, then the transmission control node may decide to adjust the bitrate. Such adjustments have to be synchronised with the delivery helper node(s) before taking place.

In other words, a short burst requires more from the connection, and if successful, it can be determined that the connection has available capacity, and the regular transmission level can be increased.

In a preferred embodiment of the present disclosure, the transmission control node may also decide to decrease the data rate based on the received acknowledgment packets and network parameters determined from them. For example, if acknowledgment packets indicate that the receipt of content packets is delayed, and that the delay increases over time, it may imply that congestion problems exists, and the transmission control node may decrease the data rate by synchronising this with the delivery helper node(s).

An advantageous embodiment of the present disclosure is obtained when the transmission control node is arranged to control the delivery helper node at least partly on the basis of properties of a further network connection established between the content receiver and the delivery helper nodes.

In an embodiment of the present disclosure, a separate connection may be established between the content receiver and the delivery helper node. The separate connection may be of any type, but a TCP connection is preferred. This embodiment may e.g. comprise the content receiver R frequently contacting the delivery helper node DHN with keep alive packets, e.g. so that the delivery helper node may discover a possible disappearance of the content receiver R before or instead of receiving that information from the transmission control node S. When receiving some amount of traffic directly from the content receiver, for example regular keep-alive messages, the delivery helper node DHN may be arranged to determine some connection parameters by itself by measuring the local round trip time RTT. The information obtained by the delivery helper node may preferably be forwarded to the transmission control node, as it may not be able to determine the same information by itself.

An advantageous embodiment of the present disclosure is obtained when the transmission control node is arranged to monitor the acknowledgement packets and control the delivery helper node to temporarily stop transmission of said content packets when the received acknowledgement packets indicate a connection irregularity.

A connection irregularity may e.g. comprise congestion situations, bottleneck packet build up, temporary loss of the connection to the content receiver, exceed TCP window size, etc.

An advantageous embodiment of the present disclosure is obtained when the transmission control node is arranged to occasionally control the delivery helper node to temporarily stop the transmission of content packets and the transmission control node is arranged to transmit packets to the content receiver while the delivery helper node transmission is temporarily stopped.

In preferred embodiments the transmission control node may take over the transmission of packets to the content receiver temporarily e.g. for resending lost packets, or in order to test the connection parameters or network capacity. Further embodiments of the disclosure where the transmission control node temporarily pauses the delivery helper node transmission and sends packets to the content receiver may e.g. comprise blocks of commercials received from a separate stream or controlled by the transmission control node.

The present disclosure further relates to a content delivery network comprising a transmission control node S and a delivery helper node DHN, the addresses of the transmission control node S and the delivery helper node DHN being different;

wherein said transmission control node S is connected to a content receiver R by a network connection negotiated in accordance with a reliable transport protocol; and

wherein the delivery helper node DHN is arranged to transmit content packets CP to said content receiver R in compliance with said negotiated network connection including being arranged to pretend transmitting from said transmission control node S.

An advantageous embodiment of the present disclosure is obtained when said pretend transmitting from said transmission control node S is arranged by the delivery helper node DHN being arranged to establish headers for said content packets CP with a source address that is an address of the transmission control node S instead of the delivery helper node DHN.

An advantageous embodiment of the present disclosure is obtained when combined with any of the above-described embodiments.

### THE DRAWINGS

The disclosure will in the following be described with reference to the drawings where:

FIG. 1 illustrates an embodiment of the disclosure,

FIG. 2 illustrates a second embodiment of the disclosure,

FIG. 3 illustrates a prior art scenario,

FIG. 4 illustrates an embodiment of the disclosure,

FIG. 5 illustrates a prior art scenario, and

FIG. 6 illustrates an embodiment of the disclosure.

### DETAILED DESCRIPTION

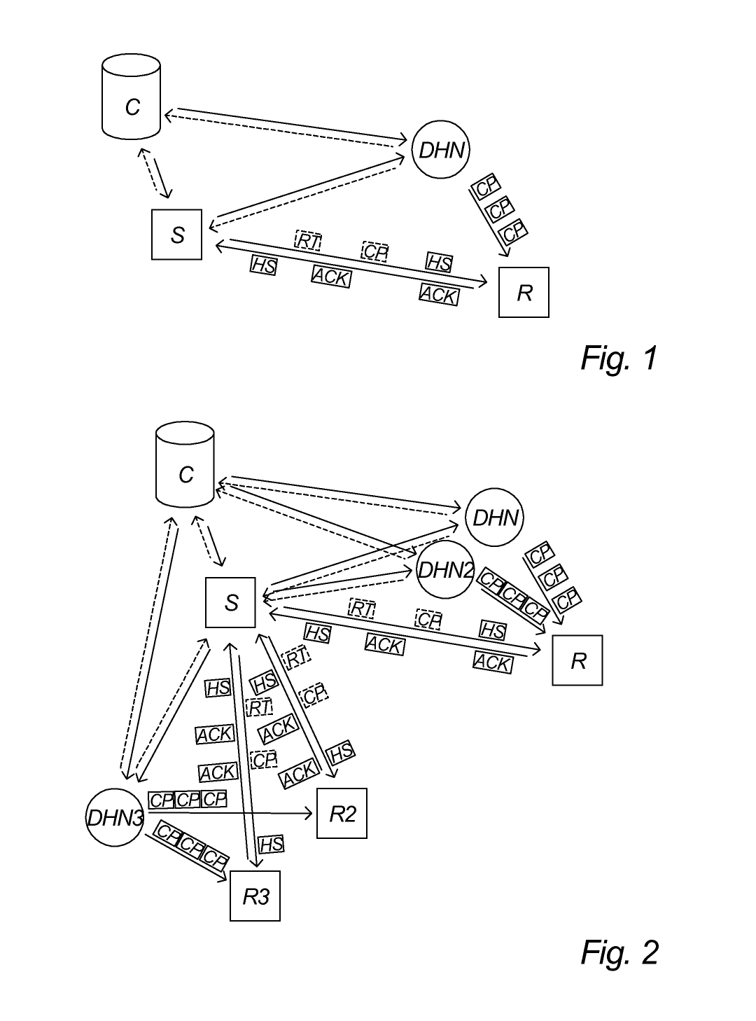

FIG. 1 illustrates an embodiment of the present disclosure comprising a content delivery network with a transmission control node S and a delivery helper node DHN working together to serve content from a content storage or generator C to the content receiver R.

The transmission control node S and the content receiver R negotiate and set up a connection in accordance with a reliable transport protocol, e.g. TCP, by means of the exchange of handshake packets as dictated by the protocol. Hence, packets, preferably IP-packets with TCP headers, flow in both directions between the transmission control node S and the content receiver R as indicated by arrows in both directions being drawn with solid line.

It is noted that when the present description refers to connections, transmitting to, receiving from or via, etc., the physical connection between the relevant components may typically comprise several network nodes, e.g. routers, switches, access points, etc. that are not mentioned, but anyway within the scope of the disclosure, as they work transparently for the type and level of the communication discussed herein. In other words, the present disclosure relates to the embodiments described in the following regardless of the mentioned connections being implemented as direct connections, dedicated connections, tunnels, routed connections, etc.

The established connection between the transmission control node S and the content receiver R according to a conventional transport protocol of the reliable type involves a mechanism to ensure that all packets are considered in the right order at the receiver. With TCP this is obtained by numbering all packets sequentially by the sender, thereby allowing the receiver to put the packets in the right order, as well as detect if a packet is not received. The receiver, here the content receiver R, informs the sender, here the transmission control node S, about packets received by transmitting acknowledgement packets ACK. The transmission control node S may indirectly know from received or not received acknowledgement packets and the timing thereof if a packet never reached the content receiver R, if the receiver's buffer is too small compared to the transmission speed, etc. In addition to sequence number, according to conventional transport protocols of the reliable type, e.g. TCP encapsulating IP, packets are marked with source address and source port number to enable the receiver to put an address on the acknowledgement packets ACK. Hence, the TCP is inherently a one-to-one transport protocol.

According to the embodiment of the disclosure illustrated in FIG. 1, the delivery helper node DHN is, however, allocated the task of transmitting at least a part of the content packets CP to the content receiver R even though the negotiated connection is in principle a one-to-one connection between the transmission control node S and the content receiver R. This is achieved according to the disclosure by having the delivery helper node DHN establish content packets in correspondence with the transport protocol of a reliable type that has been set up between the transmission control node S and the content receiver R. In a preferred embodiment the reliable transport protocol is TCP, and the delivery helper node DHN thus establishes IP content packets CP with TCP headers. In order to support the essentially one-to-one connection established, the

IP- and TCP headers established by the delivery helper node DHN comprise as their source address and source port the relevant information of the transmission control node S and not of the delivery helper node DHN itself. Further the TCP headers comprise sequence numbers in correspondence with and synchronized to the numbering used for packets between the transmission control node S and the content receiver R.

Hence, the content receiver R receives content packets CP that are in complete correspondence with what it expects to receive, but from a network point of view the heavy content traffic is at least partly redirected to a route between the delivery helper node DHN and the content receiver R, and thereby resources may be released or used for other purposes at the transmission control node S and along the route from the transmission control node S and the content receiver R.

As the content packets CP received by the content receiver R preferably comprises the address of the transmission control node S as their source address even though they come from the delivery helper node DHN, the content receiver R in full accordance with the agreed protocol transmits its acknowledgement packets ACK to the transmission control node S. In a preferred embodiment of the disclosure the content receiver R is not necessarily aware that it receives TCP packets from two or more senders that all identify the source as the transmission control node S.

In a preferred embodiment of the disclosure the transmission control node S transmits control information to the delivery helper node DHN comprising the information that the helper node needs to establish the IP- and TCP-headers in accordance with the already established connection between the transmission control node S and the content receiver R. The control information preferably comprises the address and port of the transmission control node S with which the connection is established, and the information necessary to assign the right sequence numbers to the right parts of the content, making packets of the negotiated size, etc. The connection between the transmission control node S and the delivery helper node DHN may be of any suitable type comprising both reliable, unreliable and multicast connection types, hence the dashing of the arrow line indicating communication from the delivery helper node DHN to the transmission control node S.

If the transmission control node S learns from the received or not received acknowledgement packets ACK that the content receiver R is not receiving a certain content packet CP from the delivery helper node DHN, the transmission control node S may either retransmit the missing content packet RT as indicated by a dashed packet in FIG. 1 or control the delivery helper node DHN to transmit it. In a preferred embodiment of the disclosure the delivery helper node DHN does not learn about missed packets directly from the content receiver R due to its publishing the transmission control node's address as return address instead of its own.

As illustrated by a dashed content packet CP between the transmission control node S and the content receiver R, the present disclosure in an embodiment lets the transmission control node S establish and transmit some of the content packets CP itself, for example if the content delivery from the delivery helper node DHN for a particular content receiver R proves to be inefficient, if the rate or other property of the connection to the content receiver R needs to be measured, or for example when the setting up of a connection needs firmer control than possible via the delivery helper node.

The content storage or generator C may e.g. be a data storage like a network server or cloud storage, or a data stream generator like a live event streaming video producer or an extensive live data collector. The content storage or generator C may be arranged as part of either the transmission control node S or the delivery helper node DHN, or as a separate network or cloud component. In a preferred embodiment of the disclosure both the delivery helper node DHN and the transmission control node S have access to the content at the content storage or generator, but either may be accessing the content via the other, or the transmission control node S may in an embodiment not have access to the entire content but only to properties or key items thereof sufficient to be able to control or initialize the connection and sequence numbering. The type of connection for transmitting the content from the content storage or generator C to the transmission control node S and the delivery helper node DHN may be of any suitable type, comprising reliable, unreliable or multicast types; hence the dashed return arrow lines for these connections in FIG. 1.

FIG. 2 illustrates a few further concepts of embodiments of the present disclosure. In one part of FIG. 2 a content storage or generator C is connected to a transmission control node S, which again establishes a connection of a reliable transport protocol type with a content receiver R, as described above with reference to FIG. 1. In the embodiment of FIG. 2, the transmission control node S informs two delivery helper nodes DHN, DHN2 about the connection and thereby enables two delivery helper nodes to take over the work of transmitting content packets CP to the content receiver R. The work may be distributed between the two delivery helper nodes according to different schemes corresponding to the circumstances. In an embodiment of the disclosure the delivery helper nodes DHN, DHN2 have the work split between them so that content can be delivered faster if facilitated by the content receiver. In an alternative embodiment of the disclosure the work is split in order to balance the resources of the delivery helper nodes, e.g. if one of them is also doing other work. In yet an alternative embodiment of the disclosure the work is done by the delivery helper node that performs best, with the possibility to direct work to the other delivery helper node if necessary. In yet an alternative embodiment of the disclosure both delivery helper nodes establish and transmit the same content packets, making two of each content packet being sent towards the content receiver, which in certain network circumstances may increase the chance of at least one of them reaching the content receiver.

FIG. 2 further illustrates an embodiment of the disclosure where two content receivers R2, R3 establish reliable-protocol connections with the transmission control node S, which informs or controls a delivery helper node DHN3 to handle the establishment and transmission of content packets CP to both content receivers R2, R3.

It is noted that embodiments of the present disclosure are not restricted to the one or two of each component as appearing in the illustrations for simplicity. Hence, embodiments of the disclosure may also comprise three or more delivery helper nodes working together and/or three or more content receivers establishing connections with one or more transmission control nodes in order to receive content packets from one or more delivery helper nodes. When an embodiment of the disclosure comprises two or more delivery helper nodes, they may each access the content from the content storage or generator, or via a transmission control node S, or via another delivery helper node.

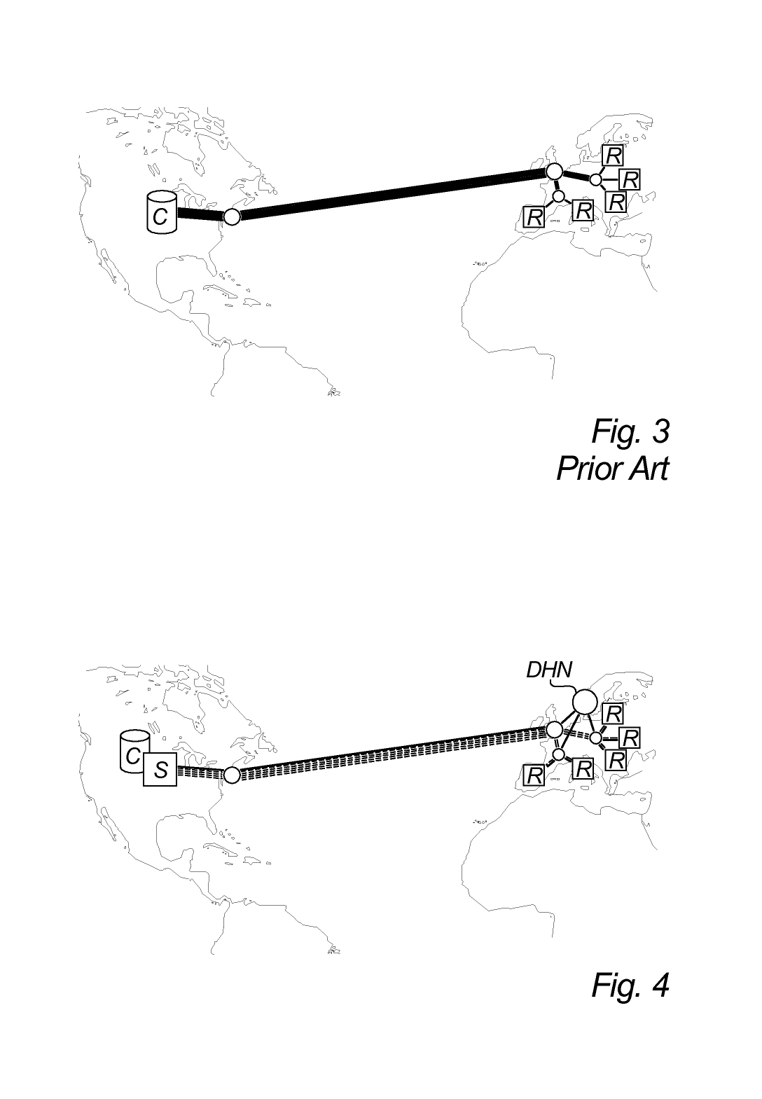

A setting where the present disclosure is particular useful is in content delivery networks that serve content to several content receivers located far away, being it far in network terms or geographically. When a reliable-type transport protocol such as TCP is applied conventionally for transferring heavy content to several users, the connection-oriented and reliable protocol means that several connections have to be established in parallel even though they often, for example in the case of streaming of live events or television broadcasts, all convey the same content packets. With long distances in a network this typically means that the several TCP connections go through a lot of network nodes, and if several content receivers are located in the same direction, this probably means that the several TCP connections go through the same lot of network nodes a certain part of the way. Burdening a lot of network nodes with several instances of the same content just because it is eventually going to different receivers is a bottleneck in using TCP conventionally. With geographically long distances a similar bottleneck occurs, as typically only a few main routes tie isolated geographic sites together, like major cities in the USA or continents like North America and Europe, etc. This prior art situation is illustrated in FIG. 3, where for example several content receivers R in Europe request delivery by TCP of the same live video stream from a US-based content server C. The Atlantic connection will have to convey several equal TCP streams in parallel, all carrying the same, heavy content as illustrated by the five bold, parallel lines connecting North America with Europe in FIG. 3.

FIG. 4 illustrates an embodiment of the present disclosure being particularly useful in the scenario discussed above. Again, 5 content receivers R in Europe establish TCP connections to a transmission control node S and request transmission of a live content stream from the content storage or generator C. However, in this embodiment a delivery helper node DHN is located in Europe and receives the heavy content stream from North America as illustrated by the single bold, solid line. Upon establishment of the individual TCP connections to each content receiver R, the transmission control node S provides information to the delivery helper node DHN about the connections as described above with reference to FIG. 1 to enable the delivery helper node DHN to establish TCP content packets and transmit them internally in Europe to the content receivers R. The TCP content packets established by the delivery helper node are as described above established with headers that make the content receivers R believe that they are receiving the content packets from the transmission control node S, but in fact the only data traffic between the content receivers R and the transmission control node S, i.e. through the bottleneck, is the connection negotiation packets, handshaking, acknowledgement packets and possibly certain retransmissions of missed content packets. This relatively light part of the five TCP connections are illustrated by the five dashed, thinner connection lines, whereas the heavy content traffic is only transmitted by one connection through the bottleneck, as illustrated by the single, bold line.

Alternatives to the embodiment in FIG. 4 may e.g. comprise embodiments with several delivery helper nodes located in the remote location, here Europe, for serving different groups of content receivers R or for serving the same content receivers R simultaneously, e.g. by any of the schemes discussed above with reference to FIG. 2. Other alternative embodiments within the scope of the disclosure may comprise several different content streams, possibly served by different transmission control nodes, using the same delivery content helpers in the remote location.

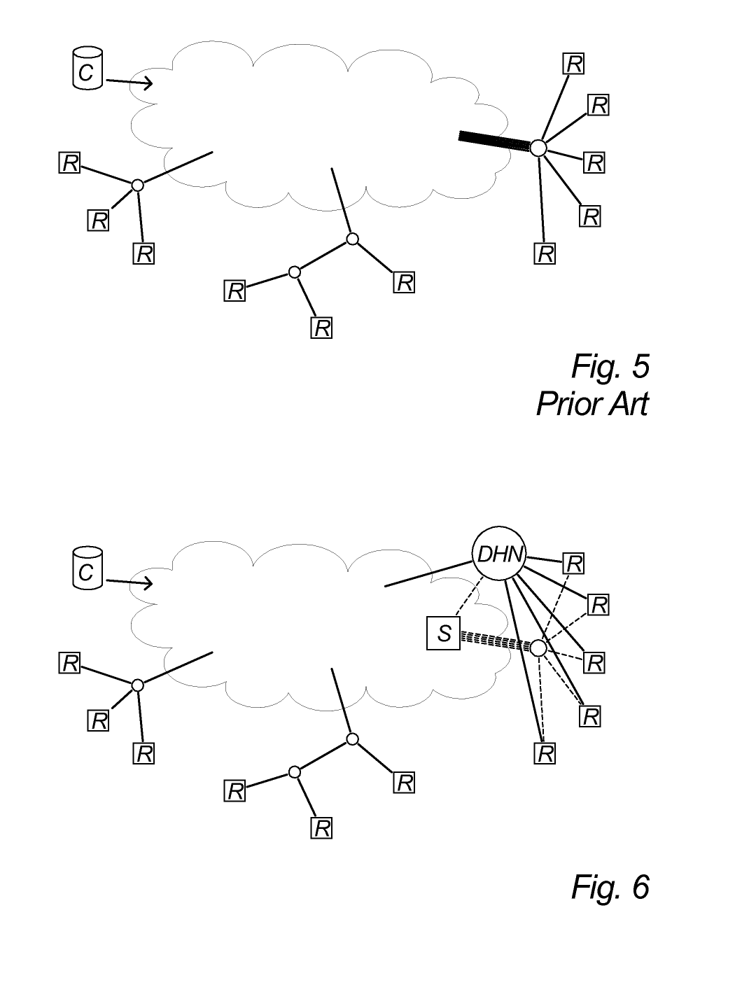

An example of a cloud-based content delivery network is shown in the prior art-related FIG. 5. A content server is providing content to the cloud, and several content receivers R are obtaining the content from the cloud. The bold, solid lines represent heavy content transmissions. Some of the content receivers R or network routers outside the cloud support a multicast protocol or other scalable delivery method meaning that the cloud is serving a single content stream that is eventually received by several content receivers R, e.g. as illustrated in FIG. 5 where one content stream from the cloud is received by three content receivers in two different ways. In this simplified example, this means that six content receivers share two heavy content streams from the cloud. But five of the content receivers require a TCP connection or similar, and need therefore to each establish a full connection to the cloud, meaning that five heavy content streams are required to serve these five content receivers. The consequence in this simplified example is that the restricted content receivers, which amount to less than half, about 45%, of the content receivers consumes about 70% of the cloud's outgoing bandwidth. As cloud bandwidth is a considerable parameter both technically and economically, this is not a desirable situation.

FIG. 6 illustrates an embodiment of the present disclosure being particularly useful in the cloud scenario discussed above. A transmission control node S as described above is inserted in the content delivery network as entry point for the five restricted content receivers that require TCP or like connections. The transmission control node S is preferably implemented as part of the cloud, but may also be established outside the cloud in certain embodiments. The five restricted content receivers negotiate their TCP connections with the transmission control node S, but the heavy content streaming is then assigned to one or more delivery helper nodes DHN as described above, which may either be implemented as part of the cloud, or located as separate nodes outside the cloud. According to this embodiment of the present disclosure, the TCP connections to the transmission control node S handle only light traffic for establishment and maintenance of the TCP connections as illustrated by the light, dashed lines, whereas the heavy traffic is handled by the delivery helper node, which requires only a single heavy traffic connection to the cloud. Comparing the simplified example of FIG. 6 with the prior art example of FIG. 5, it can be seen that a considerable number of heavy traffic connections out of the cloud have been avoided in that the 45% restricted content receivers now share a single heavy traffic connection, i.e. 33% of the cloud outgoing bandwidth, and in addition thereto only require a number of lighter maintenance connections.

A specific embodiment of the present disclosure comprises improving a scalable content delivery network that relies on multicast or other unreliable and/or less widely supported protocols and/or proprietary software so that it can also deliver content by TCP to e.g. Apple iPhones, smart TVs, gaming consoles, media centres, or other Internet-connected devices which have strict firewalls or software restrictions, and/or according to streaming standards such as HTTP Live Streaming HLS or Dynamic Adaptive Streaming over HTTP, MPEG-DASH, which both build upon the HyperText Transfer Protocol HTTP and thereby requires TCP. This may according to an embodiment of the disclosure be achieved by adding new or improving a number of the network nodes, e.g. routers, to being able to act as delivery helper nodes DHN according to the description above with reference to FIG. 1, and by inserting one or more transmission control nodes S acting as the entry point for the individual iPhones or other content receiver R devices that require TCP connections, e.g. because of HSL or MPEG-DASH requirements. According to this embodiment the transmission control nodes S have to support a relatively large number of TCP connections if many TCP-only devices request the content, but according to the disclosure, the many TCP connections from the transmission control nodes S only need to handle the setup and maintenance data traffic; the heavy content stream is distributed to the delivery helper nodes, preferably by multicast or other less demanding transport protocols.

It is noted that all the embodiments described herein, e.g. with reference to FIG. 1, 2, 4 or 6, may support the HLS standard, MPEG-DASH standard, Realtime Transport Protocol RTP, RealTime Messaging Protocol RTMP, progressive download, or other TCP-based or TCP-like streaming standards.

In another specific embodiment the delivery helper nodes DHN according to the disclosure as described above are implemented in multicast enabled network routers or automatic multicast tunnelling AMT enabled routers. Such routers are designed for receiving content by multicast or other unreliable protocols, and the AMT enabled routers are further already designed for transforming the multicast packets into packets according to other protocols, typically User Datagram Protocol UDP-like packets. According to this specific embodiment the multicast or AMT routers are now further enhanced to being able to transform received content packets into TCP-packets based on TCP connection information received e.g. from a transmission control node S as described above. It is noted that the so enhanced multicast routers or AMT routers according to this embodiment may be used for the delivery helper nodes DHN in any of the herein-described embodiments of the disclosure, including the embodiments described with reference to FIG. 1, 2, 4 or 6.

In an embodiment of the disclosure the transmission control node S is aware of several possible delivery helper nodes DHN distributed throughout a network, and is, upon request for a TCP stream from a content receiver, able to select one or more of the delivery helper nodes that seem most suitable with respect to the specific content receiver and the distribution of any already connected content receivers and/or already active delivery helper nodes, and instruct the selected delivery helper nodes DHN to obtain a certain content, e.g. by joining a specific multicast group. When the selected delivery helper nodes is receiving or has obtained the content, the transmission control node S may inform the delivery helper nodes DHN about the details of the established TCP connection with the content receiver R including information about source IP-address, packet sequence numbering, packet size, etc., thereby enabling the selected delivery helper nodes to take over the data-heavy transmission of TCP content packets to that content receiver.

A further embodiment of the present disclosure, which may be implemented on the basis of any of the other embodiments described herein, comprises the transmission control node S frequently measuring the efficiency of the transmission to the content receiver R in terms of e.g. data rate and packet loss ratio. Both of these values may be derived from the acknowledgement packets ACK which according to preferred embodiments of the disclosure are received by the transmission control node S even though the content packets may be transmitted from a delivery helper node. The data rate or bandwidth may e.g. be determined by measuring the time between receipt of two acknowledgement packets ACK and compare this to the amount of data that has been received between those two acknowledgement packets.

A further embodiment of the present disclosure, which may be implemented on the basis of any of the other embodiments described herein, comprises supporting different bitrates of the same content. This may e.g. be implemented by having two or more delivery helper nodes DHN subscribing to different bitrates of the content stream, and letting the transmission control node S instruct a delivery helper node with a relevant bitrate to transmit TCP content packets to a certain content receiver R. The selection of bitrate may e.g. be done by the content receiver when requesting access to the content, or it may be decided by the transmission control node S on the basis of experienced connection efficiency, e.g. determined as described above. Further, this embodiment may allow the transmission control node S to re-allocate the transmission of content packets from a delivery helper node with one bitrate to a delivery helper node with a different bitrate if it experiences or measures a significant change in the connection efficiency or quality during the streaming session. The feature of supporting different bitrates may also or as an alternative be achieved in an embodiment by letting each delivery helper node have access to several streams with different bitrates simultaneously, or by letting the transmission control node S provide the streaming option of, preferably, a low bitrate, and having the delivery helper nodes provide streaming with higher bitrates.

In a further embodiment of the present disclosure based on any of the embodiments described herein, the transmission control node S is arranged to be able to instruct the delivery helper node DHN to pause or slow down the transmission to a content receiver R temporarily in order to not exceed the content receiver's TCP receive window size. The transmission control node S may work towards avoiding exceeding the window size based e.g. on the timing and content of acknowledgement packets.

A further embodiment of the present disclosure, which may be implemented on the basis of any of the other embodiments described herein, comprises discovery of the delivery helper nodes, for example by Anycast inquiries and/or Domain Name System DNS lookup or Reverse DNS lookup, e.g. based on the IP address of the transmission control node S and/or the content receiver R. When the delivery helper nodes are implemented in network devices with other functions as well, e.g. AMT relays, the IP address of the delivery helper node may preferably equal the address that can be found by a discovery process for the, e.g., AMT relay.

A further embodiment of the present disclosure, which may be implemented on the basis of any of the other embodiments described herein, comprises the delivery helper node DHN being implemented as part of a local gateway, e.g. a home router, fiber network router, cable router, DSL router, WiFi router, tablet, smartphone, PC or laptop, etc. By providing a delivery helper node locally, e.g. in a home or company, is avoided having the same content stream going in along several parallel TCP connections, e.g. if several smart-TV's, tablets, etc., request the same content, thereby potentially reducing the bandwidth usage of the external Internet connection, which is usually the bottleneck in homes or companies.

In a further embodiment of the present disclosure based on any of the embodiments described herein, the content receiver R may also transmit information to a delivery helper node DHN by establishing a separate TCP connection for that purpose. The content receiver R may e.g. obtain the address of the delivery helper node DHN from the transmission control node S, or the delivery helper node DHN may request establishment of a separate TCP connection using its own address as source address for that connection. This embodiment may e.g. comprise the content receiver R frequently contacting the delivery helper node DHN with keep alive packets, e.g. so that the delivery helper node may discover a possible disappearance of the content receiver R before or instead of receiving that information from the transmission control node S. When receiving some amount of traffic directly from the content receiver, for example regular keep-alive messages, the delivery helper node DHN may be arranged to determine some connection parameters by itself by measuring the local round trip time. The delivery helper node may e.g. use this for performing rate-based congestion control, or for determining considerable differences between the connection from the delivery helper node to the receiver compared with the connection from the transmission control node to the receiver. In several scenarios where the present disclosure is advantageous is may very well be that the TCP throughput from the helper node to the receiver is better than the throughput from the transmission control node to the receiver, because the helper node is preferably closer to the receiver, in terms of network hops and/or geographically, and is preferably located on the receiver side of any bottleneck between the transmission control node and the content receiver. In an embodiment of the disclosure, the information from the content receiver R to the delivery helper node DHN may include all or part of the information necessary for the delivery helper node to establish the TCP content packets, and further information from the transmission control node S may thereby be fully or partly dispensed of.

In a further embodiments of the present disclosure based on any of the embodiments described herein, the transmission control node S may use the established TCP or the like connection to the content receiver R for sending other or alternative data, e.g. the same content at a lower bitrate, information about other content or qualities, or e.g. advertisements being part of the pricing model subscribed to by the content receiver. In an embodiment of the disclosure, this may be achieved by the transmission control node S instructing the delivery helper node DHN to pause its transmission at a certain packet sequence number, and then take over the transmission of TCP packets until the alternative content has been transmitted, and then instruct the delivery helper node to resume transmission and informing it about the relevant next sequence number. In an alternative embodiment the transmission control node S does not assign all the content packet transmission to the delivery helper node DHN, but only instructs it to e.g. transmit every second or third packet, and the transmission control node transmitting the rest, thereby using the delivery helper nodes for only reducing the load on the transmission control node instead of completely taking over.

In a further embodiment of the present disclosure based on any of the embodiments described herein, a transmission control node S may be responsible for the establishment of a TCP or the like connection to a content receiver and allocate the heavy content transmission to a delivery helper node as described above, but may further allocate some or all of the connection maintenance to a different network component, e.g. for taking care of retransmissions of lost packets. In an alternative embodiment the transmission control node S may reassign all its responsibilities to a different transmission control node, e.g. if another control node is performing better or is more relevant to use for other reasons.

Having now described our invention, what we claim is set forth below.

1. A content delivery method for delivering content to a content receiver (R) in a network comprising a transmission control node (S) and one or more delivery helper nodes (DHN), both the transmission control node (S) and the delivery helper node (DHN) having access to said content, the content delivery method comprising
negotiating a network connection in accordance with a reliable transport protocol between said transmission control node (S) and said content receiver (R), the negotiated network connection at least comprising the content receiver (R) receiving content packets (CP) and sending acknowledgment packets (ACK);
controlling said one or more delivery helper nodes (DHN) to establish content packets (CP) with headers in accordance with said negotiated network connection;
transmitting the established content packets (CP) from said delivery helper nodes (DHN) to said content receiver (R);
transmitting said acknowledgement packets (ACK) from said content receiver (R) to said transmission control node (S).

2. The content delivery method according to claim 1, wherein said reliable transport protocol is a Transmission Control Protocol (TCP), and said unreliable transport protocol is one of: a User Datagram Protocol (UDP) and a multicast protocol.

3. The content delivery method according to claim 1, wherein the content delivery method comprises the delivery helper nodes having access to said content by receiving content packets representing said content in accordance with an unreliable transport protocol.

4. The content delivery method according to claim 1, wherein the content comprises one of: live video streaming, and video-on-demand streaming.

5. The content delivery method according to claim 1, wherein the content receiver is one of: a smartphone, and a network-enabled television.

6. The content delivery method according to claim 1, wherein the delivery helper node is implemented in one of: a network router, a multicast-enabled network router, an Automatic Multicast Tunneling (AMT)-enabled router, a local gateway, and a home router.

7. The content delivery method according to claim 1, wherein the transmission control node performs one of: an estimation of a network connection capacity, an estimate for a bandwidth of the negotiated network connection, and a measure for a packet loss ratio of the negotiated network connection.

8. The content delivery method according to claim 1, wherein said content delivery method comprises controlling the one or more delivery helper nodes at least partly on the basis of an estimated measure for a network capacity, bandwidth or a packet loss ratio, of the negotiated network connection.

9. The content delivery method according to claim 1, wherein the transmission control node is arranged to determine a content bitrate at least partly on the basis of quality properties of the negotiated network connection.

10. The content delivery method according to claim 1, wherein the transmission control node determines a content bitrate and selects the delivery helper node from a set of delivery helper nodes with associated bitrates of said content, at least partly on the basis of said determined content bitrate.

11. The delivery method according to claim 1, wherein the number of content packets transmitted to said content receiver in order to determine network or receiver capacity is transmitted at a higher data rate or more frequently than previous content packets in order to determine if a faster connection is possible.

12. The content delivery method according to claim 1, wherein the transmission control node is arranged to control the delivery helper node at least partly on the basis of properties of a further network connection established between the content receiver and the delivery helper node.

13. The content delivery method according to claim 1, wherein the transmission control node is arranged to occasionally control the delivery helper node to temporarily stop the transmission of content packets and the transmission control node is arranged to transmit packets to the content receiver while the delivery helper node transmission is temporarily stopped.

14. A delivery helper node (DHN) arranged in a network, the delivery helper node (DHN) having access to a content, wherein the delivery helper node (DHN) is further arranged to
receive control information from a transmission control node (S) about a negotiated network connection between the transmission control node (S) and a content receiver (R), the negotiated network connection being in accordance with a reliable transport protocol;
establish content packets (CP) which have headers according to said reliable transport protocol; and
transmit the established content packets (CP) to a content receiver (R);
wherein said content packets (CP) are established on the basis of said content and said control information, and wherein a source address in said headers represents an address associated with said negotiated network connection, the source address being different from an address of said delivery helper node (DHN).

15. A transmission control node (S) arranged in a network, the transmission control node (S) having access to a content, wherein the transmission control node (S) is further arranged to
negotiate a network connection between the transmission control node (S) and a content receiver (R), the negotiated network connection being in accordance with a reliable transport protocol;
transmit control information about the negotiated network connection to a delivery helper node (DHN);
allocate to said delivery helper node (DHN) the transmission to said content receiver (R) of at least some content packets (CP) established on the basis of said content and said control information; and
receive acknowledgement packets (ACK) associated with at least some of said content packets (CP) from said content receiver (R);
wherein said content packets (CP) are established with headers in accordance with a reliable transport protocol, and wherein a source address associated with said negotiated network connection is different from an address of said delivery helper node (DHN).

16. A content delivery network comprising a transmission control node (S) and a delivery helper node (DHN), the addresses of the transmission control node (S) and the delivery helper node (DHN) being different;
wherein said transmission control node (S) is connected to a content receiver (R) by a network connection negotiated in accordance with a reliable transport protocol; and
wherein the delivery helper node (DHN) is arranged to transmit content packets (CP) to said content receiver (R) in compliance with said negotiated network connection including being arranged to pretend transmitting from said transmission control node (S).

17. The content delivery network according to claim 11, wherein the pretend transmitting from said transmission control node (S) is arranged by the delivery helper node (DHN) being arranged to establish headers for said content packets (CP) with a source address that is an address of the transmission control node (S) instead of the delivery helper node (DHN).
